(19) United States
(12) Patent Application Publication
(10) Pub. No.: US 2009/0308925 A1
(43) Pub. Date: Dec. 17, 2009

(54) Electronic data capturing system that simulates the functionality of physical electronic data capture

(75) Inventors: Chen Yi Kao, Hsinchu City (TW); Chen Chun Chao, Hsinchu City (TW)

Correspondence Address: BACON & THOMAS, PLLC, 625 SLATERS LANE, FOURTH FLOOR, ALEXANDRIA, VA, 22314-1176, US

(73) Assignee: Hyweb Technology Co., Ltd., Hsinchu City (TW)

(21) Appl. No.: 12/292,158

(22) Filed: Nov. 13, 2008

(30) Foreign Application Priority Data
Jun. 13, 2008 (TW) 097122044

(51) Int. Cl. G06K 7/06

(52) U.S. Cl. 235/441

(57) ABSTRACT

The present invention relates to an electronic data capturing system that simulates the functionality of a physical electronic data capture (EDC), wherein the electronic data capturing system comprises a card reader, a client-end computer, a remote server, which are being connected in the above sequence, wherein the remote server is for simulating the functionality of an electronic data capture, and provides an electronic data capturing interface for being accessed by a web-page accessing means installed in the client-end computer, in such a manner that a card reader controlling unit installed in the client-end computer controls the card reader to read the card information from the card, the card information read from the client-end computer is sent through the web-page accessing means to the remote server, and transmitted to an acquiring server so as to proceed authorization for the transaction record, and the authorization result is then sent back from the remote server through the web-page accessing means and transmitted back to a screen on the client-end computer so that the authorization result is identified.

### FIELD OF THE INVENTION

The present invention relates to an electronic data capturing system that simulates the functionality of physical electronic data capture. The present invention simulates an electronic data capture(s) by means of a remote server and a client-end computer, so that it omits the necessity of installing physical electronic data capture(s). The card to be read by the electronic data capturing system of the present invention is any card selected from a credit card, an electronic purse (or cash card), a member loyalty card.

### BACKGROUND OF THE INVENTION

An electronic data capture, hereinafter referred to as EDC, is a device for reading electronic data from a credit card, a cash card, or a member loyalty card and transmitting transaction records. The EDC generally is provided with a slot for being connected with either a contact card reader or contact-less card reader, or directly embedded itself with a card reader. As in FIG. 2, it shows a conventional EDC 22 equipped with a card slot for being connected with a contact card. After EDC 22 reads electronic data from the card 21 by a card reader equipped therein, the electronic data is uploaded to an acquiring server 24 for executing a security controlling process and for executing bonus point process such as loyalty campaign activity. Then the acquiring server 24 sends the electronic data to the EDC 22, and if necessary writes data back to the card 21 such as writing the bonus points to the card. In order to process the above, the EDC 22 is required to provided with a processing means, memory means, input/output means, which are not shown, in order to communicate data with the remote server such as authorization code, card information, bonus points, etc. In FIG. 2, the point-of sale (POS) terminal 23 is with cash register function.

The physical EDC 22 in FIG. 2 is provided with processing means, memory means, input/output means, so the cost is rather expensive in an extent about US$300. In addition, the physical sale point, i.e. the merchant, may need to pay extra deposit or rental fee in a specific period.

Moreover, based on the limitation in size and cost, the functionality of the EDC is to be limited. For example, the screen of the conventional EDC is less than 3 inches, so that it only provides with simple operation menus. Furthermore the page switching is always required for such a small screen. Further, the memory built in the EDC is within 4 Mega Bytes, and thus it limits the data storage. Therefore, when it requires to upgrade the function of EDC such as bonus points application, the memory of EDC will be insufficient.

In addition, when the function of EDC is to be updated, the EDC vender needs to dispatch engineer to the physical sale point (i.e. merchant) to replace the application with a new one. It is complicated, time wasting, and cost-high. Furthermore, since the contact-less card, which is advantageous in high-speed transaction, becomes more and more popular, but now the contact reader is widely used, which needs to slide card through the reading slot of the card reader, therefore, when it needs to read a contact-less card, the sale point (i.e. merchant) only with a contact card reader will not be in service unless the sale point (i.e. merchant) achieves to buy a contact-less card reader. It therefore becomes a financial burden for the sale point (i.e. merchant).

More, in spite the transactions are finished, the transaction records previously stored in the physical EDC are required to be conciliated via a settlement transaction with the acquiring server. Therefore, once the EDC is out of order to loss the stored transaction records, it becomes a complicated situation for the physical sale point (i.e. merchant) and the acquiring server to recover the accident.

Accordingly, how to provide EDC with low cost, high functionality, low maintenance, high compatibility, high reliability are concerns.

### SUMMARY OF THE INVENTION

The present invention provides an electronic data capturing system that simulates the functionality of physical electronic data capture, with advantages in low cost, high functionality, low maintenance, low compatibility, high reliability, so that it relieves the necessity of installing physical EDC by means of simulation through a remote server and a client-end computer.

The present invention integrates the processing means, memory means and input/output means of physical EDCs into the client-end computer so as to relieve the necessity of installing physical EDCs. In addition, the web-page accessing means in the client-end computer can provide users with friendly operation menus. The remote server not only provides powerful function but also simulates the electronic data capturing functionality of physical EDCs. The transaction records of the present invention are directly stored in a database connecting with the remote server, so as to keep the transaction records safer.

The present invention replaces the conventional EDC, which is more than US$300, with a reader, which is less than US$10. The cost is sharply down.

The present invention not only provides web-page accessing means with a variety of friendly operation menus, but also breaks the limitation in storage space by means of the remote server, whose memory space is much less limited as compared with a physical EDC, so that in addition that more storage data can be stored, the management of EDCs becomes centralized and easier, the data maintenance also becomes easier, and the software updating is much less complicated.

In other words, the advantages of low cost, high functionality, low maintenance, high compatibility, high reliability are achieved by an electronic data capturing system that simulates the functionality of physical electronic data capture in the present invention.

### BRIEF DESCRIPTION OF THE DRAWINGS

FIG. 1 is a structural view of the electronic data capturing system that simulates the functionality of electronic data capture(s).

FIG. 2 is a structural view of the conventional electronic data capturing system that is provided with physical electronic data capture(s).

### DETAILED DESCRIPTION OF THE INVENTION

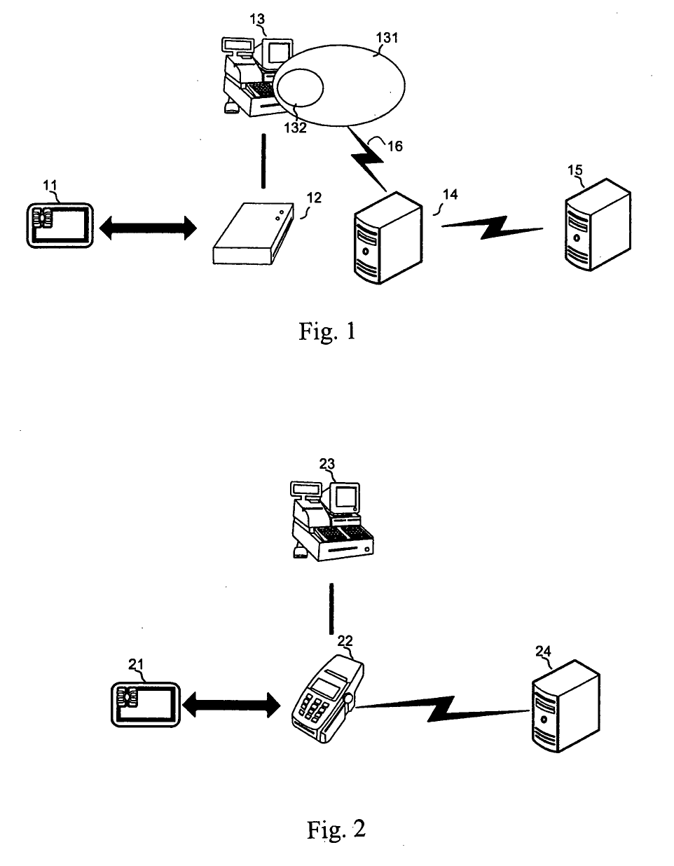

In FIG. 1, it shows a structural view of an electronic data capturing system 1 of the present invention that simulates the functionality of physical electronic data capture. The electronic data capturing system 1 of the present invention provides a card reader 12, a client-end computer 13, a remote server 14, wherein the client-end computer 13 is installed with a web-page accessing means 131, and the card reader 12 is optionally selected from a contact reader or a contact-leas reader, or both.

The client-end computer 13 can be either a personal computer or a point-of-sale (POS) terminal 23, wherein the memory space of the client-end computer 13 is larger than that of the conventional EDC 22 as shown in FIG. 2. Therefore, a web-page accessing means 131, such as a web browser, is allowed to be executed to receive the data from a remote server 14. A card reader controlling unit 132 such as ActiveX or Java Applet is installed in the web-page accessing means 131 to control the card reader 12, which is either a contact card reader or a contact-less card reader, to read data from a card 11. The card reader 12, being connected with the client-end computer 13, can be either a contact card reader or a contact-less card reader or both, which are separately plugged into slots, not shown, of the client-end computer 13.

The remote server 14 is a web server for simulating all EDCs, such as the element 22 shown in FIG. 2, located in physical sale point, and for providing the functionality and screen data that the simulated EDCs need. The remote server 14 connects and communicates with the client-end computer 13 via network connection 16, such as WAN, LAN, Internet by using TCP/IP, so as to provide all functionality needed for EDC simulation, and to display data on the screen of the client-end computer 13. Since the screen of the client-end computer 13 is larger than the screen of the conventional EDC 22 as FIG. 2, therefore the remote server 14 is allowed to provide users with a more varied associated service such as bonus point and loyalty campaign and more friendly operation_menus, i.e. single screen with more menu items for a transaction.

When in a physical sale point, the staff turns on power of the client-end computer 13, the remote server 14 starts to provide the web-page accessing means 131 by means of electronic data interface with the above varied and friendly menus and functionality for being displayed on the screen of the client-end computer 13. When a customer puts the card 11 through the card reading area of the card reader 12, the staff in the sale point sends a card reading command by selecting items on the screen of the client-end computer 13 to instruct the card reader controlling unit 132 installed in the client-end computer 13 to control a card reader 12 to read data from the card 11. The read data is fetched in the client-end computer 13 as a transaction record. The transaction record is then sent from the web-page accessing means 131 of the client-end computer 13 to the remote server 14 via network connection 16, and then is transmitted to the acquiring server 15 and stored in a database (not shown) being connected with the remote server 14. After the acquiring server 15 authorizes the transaction record, the authorization result is then in reverse path to send back the result, that is in a path from the remote server 14 to the web-page accessing means 131 and then to the screen on the client-end computer 13. Thus the staff in the sale point can understand the authorization is successful or not.

The present invention allows the contact-less card reader to read data from a contact-less card, and the contact card reader to read data from a contact card.

When it requires to add the functionality such as bonus point campaign, then the functionality is allowed to be added in the remote server 14. After the transaction record is authorized by the acquiring server 15, the data related to the bonus point campaign is sent together with the authorization result from the acquiring server 15, through remote server 14, web-page accessing means 131, to the client-end computer 13. When writing the updated bonus point to the card 11 is required, the card reader controlling unit 132 for controlling the card 11 installed in the web-page accessing means 131 will thus control this writing if the card 11 is in an accessible range of the card reader, and thus writing the updated bonus point to the card 11 is achieved.

It should be understood by those skilled in the art that various modifications, combinations, sub-combinations and alternations may occur depending on design requirements and other factors insofar as they are within the scope of the appended claims or the equivalents thereof.

1. An electronic data capturing system that simulates the functionality of electronic data capture, wherein the electronic data capturing system comprises a card reader, a client-end computer, a remote server, which are being connected in the above sequence, wherein
the remote server is for simulating the functionality of an electronic data capture, and provides an electronic data capturing interface for being accessed by a web-page accessing means installed in the client-end computer, in such a manner that a card reader controlling unit installed in the client-end computer controls the card reader to read the card information from the card,
the card information read from the client-end computer is sent through the web-page accessing means to the remote server, and transmitted to an acquiring server so as to proceed authorization for the transaction record, and the authorization result is then sent back from the remote server through the web-page accessing means and transmitted back to a screen on the client-end computer so that the authorization result is identified.

2. An electronic data capturing system as claimed in claim 1, wherein the remote server is for providing all client-end computers being connected with the remote server with electronic data capturing functionality.

3. An electronic data capturing system as claimed in claim 1, wherein when the remote server is installed with the functionality of bonus point campaign, the authorization result is sent from the remote server through the web-page accessing means to the client-end computer, and the card reader controlling unit is used to write bonus points to the card.

4. An electronic data capturing system as claimed in claim 1, wherein the card reader is either a contact card reader or a contact-less card reader or both, and the connection between the web-page accessing means and the remote server is via network.

5. An electronic data capturing system as claimed in claim 1, wherein when the authorization result indicates it needs to write data to the card, the web-page accessing means uses the card reader controlling unit to control the card reader to write data to the card.

6. An electronic data capturing system as claimed in claim 1, wherein each transaction record is directly recorded in a database being connected with the remote server.

7. An electronic data capturing system as claimed in claim 1, wherein the web-page accessing means uses the card reader controlling unit to control the card reader to read/write data from/to the card.

8. An electronic data capturing system as claimed in claim 1, wherein the client-end computer is either a point-of-sale (POS)_terminal or a computer for executing the process of the web-page accessing means.
